(19) United States
(12) Patent Application Publication
(10) Pub. No.: US 2006/0069678 A1
(43) Pub. Date: Mar. 30, 2006

(54) Method and apparatus for text classification using minimum classification error to train generalized linear classifier

(76) Inventors: Wu Chou, Basking Ridge, NJ (US); Li Li, Bridgewater, NJ (US)

Correspondence Address: Ryan, Mason & Lewis, LLP, Suite 205, 1300 Post Road, Fairfield, CT, 06824, US

(21) Appl. No.: 10/955,914

(22) Filed: Sep. 30, 2004

(51) Int. Cl. G06F 17/00

(52) U.S. Cl. 707/5

(57) ABSTRACT

Methods and apparatus are disclosed for generating a classifier for classifying text. Minimum classification error (MCE) techniques are employed to train generalized linear classifiers for text classification. In particular, minimum classification error training is performed on an initial generalized linear classifier to generate a trained initial classifier. A boosting algorithm, such as the AdaBoost algorithm, is then applied to the trained initial classifier to generate m alternative classifiers, which are then trained using minimum classification error training to generate m trained alternative classifiers. A final classifier is selected from the trained initial classifier and m trained alternative classifiers based on a classification error rate.

### FIELD OF THE INVENTION

The present invention relates generally to techniques for classifying text, such as electronic mail messages, and more particularly, to methods and apparatus for training such classification systems.

### BACKGROUND OF THE INVENTION

As the amount of textual data that is available, for example, over the Internet has increased exponentially, the methods to obtain and process such data have become increasingly important. Automatic text classification, for example, is used for textual data retrieval, database query, routing, categorization and filtering. Text classifiers assign one or more topic labels to a textual document. For document routing, topic labels are chosen from a set of topics, and the document is routed to the labeled destination according to the classification rules of the system. One important application of text routing is natural language call routing that transfers a caller to the desired destination or to retrieve related service information from a database.

The classifiers are often trained on pre-labeled training data rather than, or subsequent to, being constructed by hand. A generalized linear classifier (GLC), for example, has been employed to classify emails and newspaper articles, and to perform document retrieval and natural language call routing in human-machine communication. Current classifier design algorithms do not guarantee that the final classifier after training is a globally optimal one, and the performance of the classifier is often plagued by the sub-optimal local minimums returned by the classifier trainer. This issue is even more acute in minimum classification error (MCE) based classifier design, and overcoming the local minimum in the classifier design has become crucial. Despite the popularity and success of generalized linear classifiers, a need still exists for effective training algorithms that can improve the performance of text classification.

### SUMMARY OF THE INVENTION

Methods and apparatus are described for generating a classifier in the multiclass pattern classification tasks, such as text classification, document categorization, and natural language call routing. In particular, minimum classification error techniques are employed to train generalized linear classifiers for text classification. The disclosed methods search beyond the local minimums in MCE based classifier design. The invention is based on an intelligent use of a re-sampling based boosting method to generate meaningful alternative initial classifiers during the search for the optimal classifier in MCE based classifier training.

According to another aspect of the invention, many important text classifiers, including probabilistic and non-probabilistic text classifiers, can be unified as instances of the generalized linear classifier and, therefore, methods and apparatus described in this invention can be employed. Moreover, a method of incorporating prior training sample distributions in MCE based classification design is described. It takes into account the fact that the training samples for each individual class is typically unevenly distributed, and if not handled properly, can have an adverse effect on the quality of the classifier.

A more complete understanding of the present invention, as well as further features and advantages of the present invention, will be obtained by reference to the following detailed description and drawings.

### BRIEF DESCRIPTION OF THE DRAWINGS

FIG. 1 illustrates a network environment in which the present invention can operate;

FIG. 2 is a schematic block diagram of an exemplary incorporating features of the present invention; and

FIG. 3 is a flow chart describing an exemplary implementation of a classifier generator process incorporating features of the present invention.

### DETAILED DESCRIPTION

The present invention applies minimum classification error (MCE) techniques to train generalized linear classifiers for text classification. Generally, minimum classification error (MCE) techniques employ a discriminant function based approach. For a given family of discriminant functions, the optimal classifier design involves finding a set of parameters that minimizes the empirical error rate. This approach has been successfully applied to various pattern recognition problems, and particularly in speech and language processing.

The present invention recognizes that many important text classifiers, including probabilistic and non-probabilistic text classifiers, can be considered as generalized linear classifiers and employed by the present invention. The MCE classifier training approach of the present invention improves classifier performance. According to another aspect of the invention, an MCE classifier training algorithm uses re-sampling based boosting techniques, such as the AdaBoost algorithm, to generate alternative initial classifiers, as opposed to combining multiple classifiers to form a final stronger classifier which is the original AdaBoost and other boosting techniques intended for. The disclosed training method is applied to MCE classifier training process to overcome local minimums in optimal classifier parameter search, utilizing the fact that the family of generalized linear classifiers is closed under AdaBoost. Moreover, the loss function in MCE training is extended to incorporate the class dependent training sample prior distributions to compensate the imbalanced training data distribution in each category.

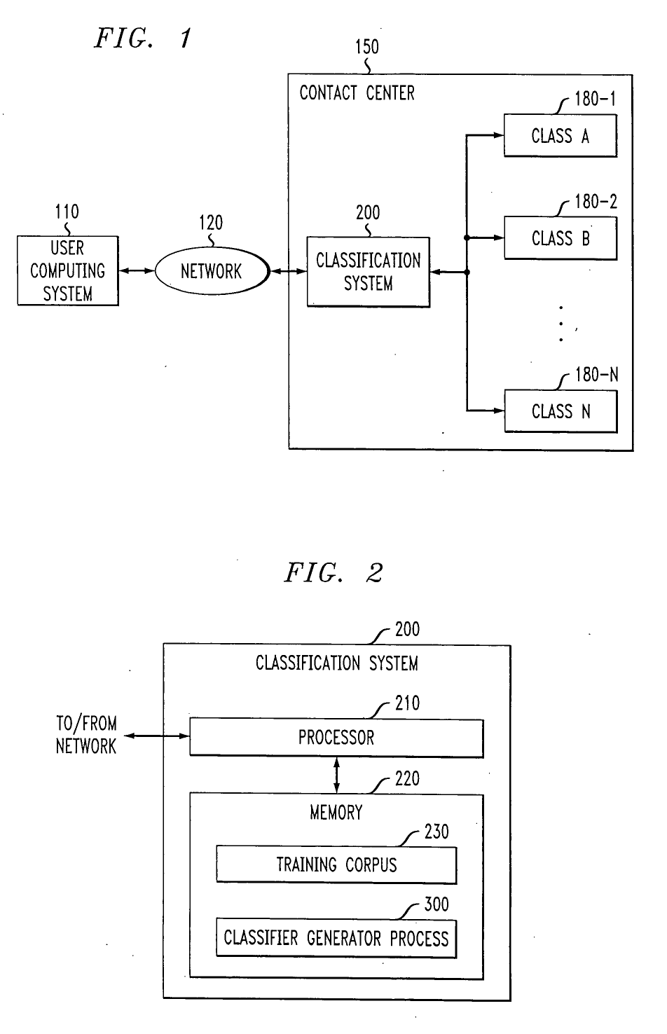

FIG. 1 illustrates an exemplary network environment in which the present invention can operate. As shown in FIG. 1, a user, employing a computing device 110, contacts a contact center 150, such as a call center operated by a company. The contact center 150 includes a classification system 200, discussed further below in conjunction with FIG. 2, that classifies the communication into one of several subject areas or classes 180-1 through 180-N (hereinafter, collectively referred to as classes 180). In one application, each class 180 may be associated, for example, with a given call center agent or response team and the communication may then be automatically routed to a given call center agent 180 based on the expertise, skills or capabilities of the agent or team. It is noted that the call center agent or response teams need not be humans. In a further variation, the classification system 200 can classify the communication into an appropriate subject area or class for subsequent action by another person, group or computer process. The network 120 may be embodied as any private or public wired or wireless network, including the Public Switched Telephone Network, Private Branch Exchange switch, Internet, or cellular network, or some combination of the foregoing. It is noted that the present invention can also be applied in a stand-alone or off-line mode, as would be apparent to a person of ordinary skill.

FIG. 2 is a schematic block diagram of a classification system 200 that employs minimum classification error (MCE) techniques to train generalized linear classifiers for text classification. Generally, the classification system 200 classifies spoken utterances or text received from customers into one of several subject areas. The classification system 200 may be any computing device, such as a personal computer, work station or server.

As shown in FIG. 2, the exemplary classification system 200 includes a processor 210 and a memory 220, in addition to other conventional elements (not shown). The processor 210 operates in conjunction with the memory 220 to execute one or more software programs. Such programs may be stored in memory 220 or another storage device accessible to the classification system 200 and executed by the processor 210 in a conventional manner.

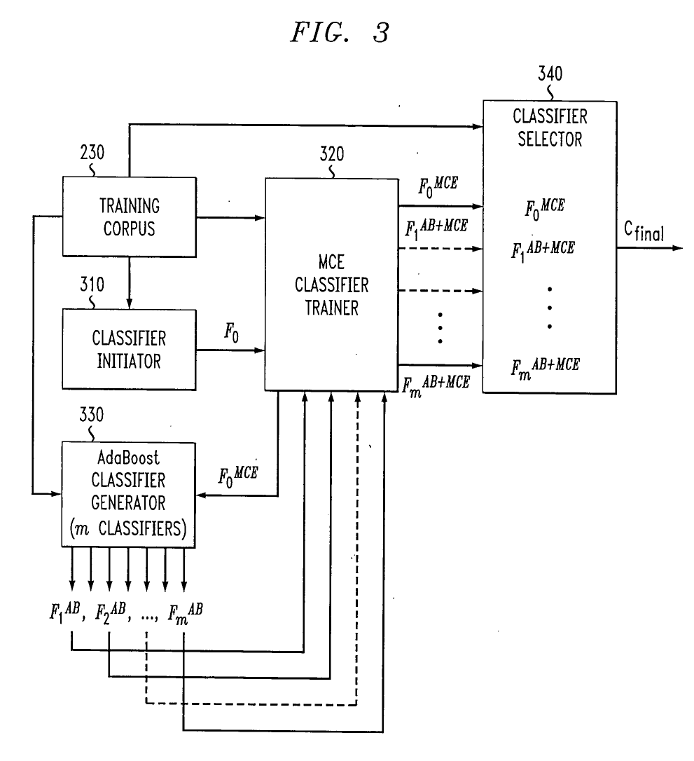

For example, the memory 220 may store a training corpus 230 that stores textual samples that have been previously labeled with the appropriate class. In addition, the memory 220 includes a classifier generator process 300, discussed further below in conjunction with FIG. 3, that incorporates features of the present invention.

### Classifier Principles

Training algorithms for text classification estimate the classifier parameters from a set of labeled textual documents. Based on the classifier building principle, classifiers are usually distinguished into two broad categories, probabilistic classifiers, such as Naïve Bayes (NB) or Perplexity classifiers, and non-probabilistic classifiers, such as Latent Semantic Indexing (LSI) or Term Frequency/Inverse Document Frequency (TFIDF) classifiers. Although a given classifier may have dual interpretations, probabilistic and non-probabilistic classifiers are generally regarded as two different types of approaches in the text classification. Training algorithms for probabilistic classifiers use training data to estimate the parameters of a probabilistic distribution, and a classifier is produced under the assumption that the estimated distribution is correct. The non-probabilistic classifiers are usually based on certain heuristics and rules regarding the behaviors of the data with the assumption that these heuristics can generalize to new text data in classification.

When training a multi-class generalized linear text classifier, training data is used to estimate the weight vector (or an extended weight vector) for each class, so that it can accurately classify new texts. Different training algorithms can be devised by varying the classifier training criterion function and the search procedure used in search for the optimal classifier parameters. In particular, a linear classifier design method is described in Y. Yang et. al., “A Re-Examination of Text Categorization Methods,” Special Interest Group on Information Retrieval (SIGIR) '99, 42-49 (1999). The disclosed linear classifier design method uses the method of linear least square fit to train the linear classifier. A multivariate regression model is applied to model the text data. The classifier parameters can be obtained by solving a least square fit of the regression (i.e., word-category) matrix on the training data. Generally, training methods based on the criterion of least-square-error between the predicted class label and the true class label on the training data lack a direct relation to the classification error rate minimization.

As discussed further below, boosting is a general method that can produce a “strong” classifier by combining several “weaker” classifiers. For example, AdaBoost, introduced in 1995, solved many practical difficulties of the earlier boosting algorithms. R. Schapire, “The Boosting Approach to Machine Learning: An Overview,” Mathematical Sciences Research Institute (MSRI) Workshop on Nonlinear Estimation and Classification (2002). In AdaBoost, the boosted classifier is a linear combination of several “weak” classifiers obtained by varying the distribution of the training data. The present invention utilizes the property that if the “weak” classifiers used in AdaBoost are all linear classifiers, the boosted classifier obtained from the AdaBoost is also a linear classifier.

### Generalized Linear Classifier (GLC)

For a given document \overline{w}, a classifier feature vector \overline{x}=(x₁, x₂, . . . , x_{N}) is extracted from \overline{w}, where xᵢ is the numeric value that i-th feature takes for that document, and N is the total number of features that the classifier uses to classify that document. The classifier assigns the document to the ĵ-th category according to:

$$\hat{j} = {arg max}_{j} ( {f}_{i} ( \overline{x} ) ) ,$$

where fⱼ(\overline{x}) is the scoring function of the document \overline{w} against the j-th category. For GLC, the category scoring function is a linear function of the following form:

$${f}_{j} ( \overline{x} ) = {β}_{j} + {\sum }_{i = 1}^{N} {x}_{i} \cdot {γ}_{ij} = u ( \overline{x} ) \cdot {\overline{v}}_{j} ,$$

where u(\overline{x})=(1, x₁, x₂, . . . , x_{N}) and \overline{vⱼ}=(βⱼ, γᵢⱼ, . . . , γ_{Nj}) are extended vectors with dimension_{(N+1)}. Based on this formulation, the following classifiers are instances of the GLC, either directly from their definition or through a proper transformation.

Naïve Bayes (NB)

Naïve Bayes (NB) classifier is a probabilistic classifier, and it is widely studied in machine learning. Generally, Naïve Bayes classifiers use the joint probabilities of words and categories to estimate the probabilities of categories given a document. The naïve part of the NB method is the assumption of word independence. In an NB classifier, the document is routed to category ĵ according to:

$$\begin{matrix}\hat{j} = {arg max}_{j} ( {P}_{j} \times {\prod }_{k = 1}^{N} {P ( {w}_{k} \vert {c}_{j} )}^{{x}_{k}} ) \\ = {arg max}_{j} ( log ( {P}_{j} ) + {\sum }_{k = 1}^{N} {x}_{k} \times log ( P ( {w}_{k} \vert {c}_{j} ) ) ) \\ = {arg max}_{j} ( u ( \overline{x} ) \cdot {\overline{v}}_{j} )\end{matrix}$$

where u(\overline{x})=(1, x₁, x₂, . . . , x_{N}) with xₖ the number of occurrences of k-th word wₖ in document \overline{w}, and \overline{vⱼ}=(βⱼ, γᵢⱼ, . . . , γ_{Nj}) with βⱼ=log(Pⱼ) and γₖⱼ=log(P(wₖ|cⱼ)). Here Pⱼ is the j-th category prior probability, and P(wₖ|cⱼ) is the conditional probability of the word wₖ in category cⱼ. Thus, an NB classifier is a GLC in the log domain, although it is originated from a probabilistic classifier according to the Bayesian decision theory framework.

Latent Semantic Indexing (LSI)

The latent semantic indexing (LSI) classifier is based on the structure of a term-category matrix M. Each selected term w is mapped to a unique row vector and each category is mapped to a unique column vector. The term-category matrix M can be decomposed through SVD (singular value decomposition) to reduce the dimension of M. It is a linear classifier because a document is classified according to:

$$\hat{j} = {arg max}_{j} \frac{\overline{x} \cdot {\overline{γ}}_{j}}{‖ \overline{x} ‖ ‖ {\overline{y}}_{j} ‖} ,$$

where \overline{x} is the document feature vector and \overline{γⱼ} is the j-th column vector of the term-category matrix M representing the j-th category.

TFIDF Classifier

In a TFIDF classifier, each category is associated with a column vector \overline{γⱼ} with
γᵢⱼ=TFⱼ(wᵢ)·IDF(wᵢ),
where TFⱼ(wᵢ) is the term frequency, i.e., the number of times the word wᵢ occurs in category j, and IDF(wᵢ) is the inverse document frequency of wᵢ. The document \overline{w} is mapped to a class dependent feature vector \overline{xⱼ} with xᵢⱼ=TFⱼ^{d}(wᵢ)·IDF(wᵢ), where TFⱼ^{d}(wᵢ) is the term frequency of wᵢ in the document. The document is classified to category

$$\hat{j} = {arg max}_{j} \frac{{\overline{x}}_{j} \cdot {\overline{γ}}_{j}}{‖ {\overline{x}}_{j} ‖ ‖ {\overline{y}}_{j} ‖} .$$

Perplexity-Based Classifier

Perplexity is a measure in information theory. Perplexity is computed as the inverse geometric mean of the likelihood of the document text:

$$pp ( {w}_{1}^{n} ) = {( p ( {w}_{1} ) {\prod }_{k = 2}^{n} p ( {w}_{k} \vert {w}_{k - 1} , … , {w}_{k - m + 1} ) )}^{\frac{1}{n}}$$

where w₁ⁿ corresponds to the document text on which the perplexity is measured, n is the size of the document and m is the order of the language model (i.e., 1-gram, 2-gram, etc.). The document is classified to the category where the class dependent language model has the lowest perplexity on the document text. A perplexity classifier corresponds to a NB classifier without category prior, and consequently, it is a GLC in the log domain as well.

Linear Least Square Fit (LLSF) Classifier

A multivariate regression model is learned from a set of training data. The training data are represented in the form of input and output vector pairs, where the input is a document in the conventional vector space model (consisting of words with weights), and output vector consists of categories (with binary weights) of the corresponding document. By solving a linear least-square fit on training pairs of vectors, one can obtain a matrix of word-category regression coefficients:

$${F}_{LS} = arg {min}_{F} {‖ FA - B ‖}^{2} ,$$

where matrices A and B present the training data (the corresponding columns is a pair of input/output vectors). The matrix F_{LS} is a solution matrix, and it maps a document vector into a vector of weighted categories. For an unknown document, the classifier assigns the document to the category which has the largest entry in the vector of weighted categories that the document vector is mapped into according to F_{LS}.

### MCE Training for Generalized Linear Classifier

As previously indicated, the minimum classification error (MCE) approach is a general framework in pattern recognition. The minimum classification error (MCE) approach is based on a direct minimization of the empirical classification error rate. It is meaningful without the strong assumption that the estimated distribution is correct as in distribution estimation based approach. For the general theory of the MCE approach in pattern recognition, see, for example, W. Chou, “Discriminant-Function-Based Minimum Recognition Error Rate Pattern Recognition Approach to Speech Recognition,” Proc. of IEEE, Vol. 88, No 8, 1201-1223 (August 2000), or W. Chou, et. al., “Pattern Recognition in Speech and Language Processing”, CRC Press, March 2003. In this section, the MCE approach for generalized linear classifier (GLC) is formulated, and the algorithmic variations of MCE training for text classification are addressed.

In MCE based classifier design, a set of optimal classifier parameters

$$\hat{Λ} = {arg min}_{Λ} {E}_{X} ( l ( X , Λ ) )$$

must be determined that minimize a special loss function that relates to the empirical classification error rate. The loss function embeds the classification error count function into a smooth functional form, and one commonly used loss function is based on the sigmoid function,

$$l ( X , Λ ) = \frac{1}{1 + {ⅇ}^{- γ d ( X , Λ ) + θ}} ( γ \geq 0 , θ \geq 0 )$$

where d(X,Λ) is the misclassification measure that characterizes the score differential between the correct category and the competing ones. It has the following form:
dₖ(x,Λ)=−gₖ(x,Λ)+Gₖ(x,Λ)
where k is the correct category for x, gₖ(x,Λ) is the score on the k-th correct class and Gₖ(x,Λ) is the function represents the competing category score. The present invention uses an N-best competing score hypotheses, Gₖ(x,Λ) that is a special η-norm (a type of softmax function)

$${G}_{k} ( x , Λ ) = {[ \frac{1}{N} {\sum }_{j = 1}^{N} {{g}_{j} ( X , {W}_{i} \vert Λ )}^{η} ]}^{1 / η} .$$

Thus, for a generalized linear classifier, the following holds:
Λ=(A,\overline{β})
gₖ(x,Λ)=^{t}Aₖ+βₖ
dₖ(x,Λ)=−gₖ(x,Λ)+Gₖ(x,Λ)

The loss function can be minimized by the Generalized Probabilistic Descent (GPD) algorithm. It is an iterative algorithm and the model parameters are updated sample by sample according to:
Λₜ₊₁=Λₜ−εₜ∇l(xₜ,Λ)|_{Λ=Λt}
where εₜ is the step size, and xₜ is the feature vector of the t-th training document. The algorithm iterates on the training data until a fixed number of iterations being reached or a stopping criterion is met. Given the correct category of xₜ is k, Aᵢⱼ and βⱼ are updated by:

$${A}_{ij} ( t + 1 ) = \{ \begin{matrix}{A}_{ij} ( t ) + {ɛ}_{t} γ {l}_{k} ( 1 - {l}_{k} ) {x}_{i} & only if j = k \\ {A}_{ij} ( t ) - {ɛ}_{t} γ {l}_{k} ( 1 - {l}_{k} ) {x}_{i} & \frac{{G}_{k} ( x , Λ ) {{g}_{j} ( x , Λ )}^{η - 1}}{{\sum }_{l \neq k}^{N} {{g}_{l} ( x , Λ )}^{η - 1}}\end{matrix} \\ {β}_{j} ( t + 1 ) = \{ \begin{matrix}{β}_{j} ( t ) + {ɛ}_{t} γ {l}_{k} ( 1 - {l}_{k} ) & only if j = k \\ {β}_{j} ( t ) - {ɛ}_{t} γ {l}_{k} ( 1 - {l}_{k} ) & \frac{{G}_{k} ( x , Λ ) {{g}_{j} ( x , Λ )}^{η - 1}}{{\sum }_{l \neq k}^{N} {{g}_{l} ( x , Λ )}^{η - 1}}\end{matrix}$$

In classifier training, the available training data 230 for each category can be highly imbalanced. To compensate for this situation in MCE-based classifier training, the present invention optionally incorporates the sample count prior

$${\hat{P}}_{j} = \frac{\vert {C}_{j} \vert}{\sum \vert {C}_{i} \vert}$$

into the loss function, where |Cⱼ| is the number of documents in category Cⱼ. For N-best competitors-based MCE training, the following loss function is used:

$${l}_{k} = \frac{1}{1 + {ⅇ}^{\{ - γ {d}_{k} ( x , Λ ) + θ ( {\hat{P}}_{k} - \frac{1}{N} {\sum }_{1 \leq i \leq N} {\hat{P}}_{j} ) \}}}$$

which gives higher bias to categories with less training samples.

### MCE Classifier Training with Boosting

As previously indicated, boosting is a general method of generating a “stronger” classifier from a set of “weaker” classifiers. Boosting has its roots in machine learning framework, especially the “PAC” learning model. The AdaBoost algorithm is a very efficient boosting algorithm. AdaBoost, referenced above, solved many practical difficulties of the earlier boosting algorithms, and found various applications in machine learning, text classification, and document retrieval. Generally, the main steps of the AdaBoost algorithm are described as follows:

1. Given the training data: (x₁,y₁) . . . (x_{N},y_{N}), where N is the total number of documents in the training corpus, and xᵢεX is a training document, and yᵢεY is the corresponding category. Initialize the training sample distribution

$${D}_{1} ( {x}_{i} ) = \frac{1}{N}$$

and set t=1.

2. Train classifier hₜ(xᵢ) using distribution Dₜ and define the classification error rate εₜ be the classification error rate of [hₜ(xᵢ)≠yᵢ] based on distribution Dₜ

3. Choose

$${α}_{t} = \frac{1}{2} log ( \frac{1 - {ɛ}_{t}}{{ɛ}_{t}} )$$

4. Update the distribution

$${D}_{t + 1} ( {x}_{i} ) = \frac{{D}_{t} ( {x}_{i} )}{{Z}_{t}} \times \{ \begin{matrix}{ⅇ}^{- {α}_{t}} & if {h}_{t} ( {x}_{i} ) = {y}_{i} \\ {ⅇ}^{{α}_{t}} & if {h}_{t} ( {x}_{i} ) \neq {y}_{i}\end{matrix}$$

where Zₜ is a normalization factor to make Dₜ₊₁ a probability distribution. The algorithm iterates by repeating step 2-4.

The classifier generated at i-th iteration is denoted by hᵢ^{AB}(x,Λᵢ^{AB}) with classifier parameter Λᵢ^{AB} for i=1, . . . , k. The final classifier after k-iterations of the AdaBoost algorithm is a linear combination of the “weak” classifiers with the following form:

$${F}_{AB} ( x , Λ ) = {\sum }_{i = 0}^{k} {α}_{i} {h}_{i}^{AB} ( x , {Λ}_{i}^{AB} )$$

where

$${α}_{i} = \frac{1}{2} log ( \frac{1 - {ɛ}_{i}}{{ɛ}_{i}} ) , {ɛ}_{i}$$

is the classification error rate according to the boosting distribution Dᵢ, and hᵢ^{AB}(x,Λᵢ^{AB}) is i-th classifier generated in the AdaBoost algorithm based on Dᵢ. The boosting process is stopped if εₖ>50%.

One method of using the AdaBoost algorithm to combine multiple classifiers is described in I. Zitouni et al., “Boosting and Combination of Classifiers for Natural Language Call Routing Systems,” Speech Communication Vol. 41, 647-61 (2003). The disclosed technique is based on the heuristic that the classifier hᵢ^{AB}(x,Λᵢ^{AB}) obtained from i-th iteration of the AdaBoost algorithm is added to the sum if it improves the classification accuracy on the training data. The reason to adopt this heuristic is that the classification performance of AdaBoost can drop when combining a finite number of strong classifiers.

One of the issues in MCE based classifier design is how to overcome a local minimum in classifier parameter estimation. This problem is acute, because the GPD algorithm is a stochastic approximation algorithm, and it converges to a local minimum depending on the starting position of the classifier during the MCE classifier training. One important property of GLC is that it is closed under affine transformation. The classifier obtained from AdaBoost in the case of GLC remains to be a GLC. The performance of the classifier obtained through AdaBoost is bounded by the achievable performance region of GLCs. On the other hand, AdaBoost on GLCs provides a method to generate meaningful alternative initial classifiers during the search for the optimal GLC classifier in MCE based classifier design.

FIG. 3 is a flow chart describing an exemplary implementation of a classifier generator process 300 incorporating features of the present invention. As shown in FIG. 3, the AdaBoost assisted MCE training process 300 of the present invention consists of the following steps:

(1) Given an initial GLC classifier F₀ (generated at step 310), do MCE classifier training at step 320 (in the manner described above in the section entitled “MCE Training for Generalized Linear Classifier,” to generate trained classifier F₀^{MCE}. Thus, according to one aspect of the invention, if a probabilistic classifier is employed, such as an NB or a perplexity-based classifier, the classifier is transformed into the log domain, where such probabilistic classifiers are instances of GLC.

(2) Using F₀^{MCE} as the seed classifier, employ the AdaBoost algorithm, as described above, during step 330 to generate m additional classifiers (Fₖ^{AB}|k=1, . . . , m).

(3) Using m classifiers from step (2) as initial classifiers, perform MCE classifier training again at step 320 and generate m MCE trained classifiers {Fₖ^{AB+MCE}|k=1, . . . , m}.

(4) The final classifier is selected during step 340 as the one having the lowest classification error rate on the training set 230 among m+1 classifiers {F₀^{MCE}, Fₖ^{AB+MCE}|k=1, . . . , m}. The classification error rate is obtained by applying the m+1 classifiers to the training corpus 230 and comparing the labels generated by the respective classifiers to the labels included in the training corpus 230.

This approach is an enhancement to the MCE based classifier training from a single initial classifier parameter setting in multi-class classifier design. Moreover, it overcomes the performance drop that can happen when combining multiple strong classifiers according to the original AdaBoost method. Most importantly, it is consistent with the framework of MCE based classifier design, and it provides a way to overcome local minimums in optimal classifier parameter search.

A key issue to the success of boosting is how the classifier makes use of the new document distribution Dᵢ provided by the boosting algorithm. For this purpose, three sampling methods were considered with replacement for building the classifiers in boosting based on distribution Dᵢ:

(1) Seeded Proportion Sampling (SPS): Each training document is used 1+NP(k) times, where N is the total number of training documents and 0≦P(k)≦1 is the distribution of the k-th document.

(2) Roulette Wheel (RW) Sampling

(3) Stochastic Universal Sampling (SUS)

When boosting and random samplings are used in classifier design, it opens a new issue in classifier term (feature) selection. In the present approach to classifier design, the term selection is based on the information gain (IG) criterion, and it is dependent on the distribution of the training samples. It measures the significance of the term based on the entropy variations of the categories, which relates to the perplexity of the classification task. The IG score of a term tᵢ, IG(tᵢ), is calculated according to the following formulas:

$$IG ( {t}_{i} ) = H ( C ) - p ( {t}_{i} ) H ( C \vert {t}_{i} ) - p ( {\overline{t}}_{i} ) H ( C \vert {\overline{t}}_{i} )$$

$$H ( C ) = - {\sum }_{j = 1}^{n} p ( {c}_{j} ) log ( p ( {c}_{j} ) )$$

$$H ( C \vert {t}_{i} ) = - {\sum }_{j = 1}^{n} p ( {c}_{j} \vert {t}_{i} ) log ( p ( {c}_{j} \vert {t}_{i} ) )$$

$$H ( C \vert {\overline{t}}_{i} ) = - {\sum }_{j = 1}^{n} p ( {c}_{j} \vert {\overline{t}}_{i} ) log ( p ( {c}_{j} \vert {\overline{t}}_{i} ) ) .$$

where n is the number of categories; H(C) is the entropy of the categories; H(C|tᵢ) is the conditional category entropy when tᵢ is present; H(C|\overline{t}ᵢ) is the conditional entropy when tᵢ is absent; p(cⱼ) is the probability of category cⱼ; p(cⱼ|tᵢ) is the probability of category cⱼ given tᵢ; and p(cⱼ|\overline{t}ᵢ) is the probability of cⱼ without tᵢ.

From the information-theoretic point of view, the IG score of a term is the degree of certainty gained about which category is “transmitted” when the term is “received” or not “received.”

The multi-variate Bernoulli model described in A. McCallum and K. Nigam, “A Comparison of Event Models for Naïve Bayes Text Classification,” Proc. of AAAI-98 Workshop on Learning for Text Categorization, 41-48 (1998), can be applied to estimate these probability parameters from the training data.

To study the effect of random sampling for classifier design, three methods of term selection during boosting were considered.

(a) Fixed term set; Terms for all classifiers are selected based on the uniform distribution and used throughout the classifier training process.

(b) Union of the term set: the set of terms used in each boosting iteration is the union of all terms selected at different iteration.

(c) Intersection of term set: The set of terms used in each boosting iteration is the intersection of all terms selected at different iteration.

Thus, according to a further aspect of the invention, the boosting distribution is used to generate the next classifier and also to change the classifier term (or feature) selection.

System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

We claim:

1. A method for generating a classifier for classifying text, comprising:
performing minimum classification error training on an initial generalized linear classifier to generate a trained initial classifier;
applying a boosting algorithm to said trained initial classifier to generate m alternative classifiers;
performing minimum classification error training on said m alternative classifiers to generate m trained alternative classifiers; and
selecting a final classifier from said trained initial classifier and said m trained alternative classifiers based on the classification error rate on a training set.

2. The method of claim 1, wherein said initial generalized linear classifier is a probabilistic classifier transformed into the log domain.

3. The method of claim 1, wherein said boosting algorithm is an implementation of an AdaBoost algorithm.

4. The method of claim 1, wherein said boosting algorithm performs a linear combination of a plurality of classifiers obtained by varying a distribution of said training set.

5. The method of claim 1, wherein said classification error rate is obtained by applying said trained initial classifier and said m trained alternative classifiers to said training set and comparing labels generated by said trained initial classifier and said m trained alternative classifiers to labels included in said training set.

6. The method of claim 1, wherein said minimum classification error training employs a loss function that incorporates training sample prior distributions to compensate for an imbalanced training data distribution in each category.

7. The method of claim 1, wherein said minimum classification error training is based on a direct minimization of an empirical classification error rate.

8. A method for generating a classifier for classifying text, comprising:
transforming a probabilistic classifier into a log domain; and
performing minimum classification error training on said transformed probabilistic classifier to generate a trained initial classifier.

9. The method of claim 8, further comprising the steps of:
applying a boosting algorithm to said trained initial classifier to generate m alternative classifiers;
performing minimum classification error training on said m alternative classifiers to generate m trained alternative classifiers; and
selecting a final classifier from said trained initial classifier and said m trained alternative classifiers based on a classification error rate on a training set.

10. An apparatus for generating a classifier for classifying text, comprising:
a memory; and
at least one processor, coupled to the memory, operative to:
perform minimum classification error training on an initial generalized linear classifier to generate a trained initial classifier;
apply a boosting algorithm to said trained initial classifier to generate m alternative classifiers;
perform minimum classification error training on said m alternative classifiers to generate m trained alternative classifiers; and
select a final classifier from said trained initial classifier and said m trained alternative classifiers based on a classification error rate on a training set.

11. The apparatus of claim 10, wherein said initial generalized linear classifier is a probabilistic classifier transformed into the log domain.

12. The apparatus of claim 10, wherein said boosting algorithm is an implementation of an AdaBoost algorithm.

13. The apparatus of claim 10, wherein said boosting algorithm performs a linear combination of a plurality of classifiers obtained by varying a distribution of said training set.

14. The apparatus of claim 10, wherein said classification error rate is obtained by applying said trained initial classifier and said m trained alternative classifiers to said training set and comparing labels generated by said trained initial classifier and said m trained alternative classifiers to labels included in said training set.

15. The apparatus of claim 10, wherein said minimum classification error training employs a loss function that incorporates training sample prior distributions to compensate for an imbalanced training data distribution in each category.

16. The apparatus of claim 10, wherein said minimum classification error training is based on a direct minimization of an empirical classification error rate.

17. An article of manufacture for generating a classifier for classifying text, comprising a machine readable medium containing one or more programs which when executed implement the steps of:
performing minimum classification error training on an initial generalized linear classifier to generate a trained initial classifier;
applying a boosting algorithm to said trained initial classifier to generate m alternative classifiers;
performing minimum classification error training on said m alternative classifiers to generate m trained alternative classifiers; and
selecting a final classifier from said trained initial classifier and said m trained alternative classifiers based on a classification error rate on a training set.

18. The article of manufacture of claim 17, wherein said initial generalized linear classifier is a probabilistic classifier transformed into the log domain.

19. The article of manufacture of claim 17, wherein said boosting algorithm is an implementation of an AdaBoost algorithm.

20. The article of manufacture of claim 17, wherein said classification error rate is obtained by applying said trained initial classifier and said m trained alternative classifiers to said training set and comparing labels generated by said trained initial classifier and said m trained alternative classifiers to labels included in said training set.
